(19) United States
(12) Patent Application Publication
(10) Pub. No.: US 2004/0161647 A1
(43) Pub. Date: Aug. 19, 2004

(54) Surge avoidance and control of a centrifugal compressor in a fuel cell system

(76) Inventors: Joseph D. Rainville, Caledonia, NY (US); James S. Siepierski, Williamsville, NY (US)

Correspondence Address: HARNESS, DICKEY & PIERCE, P.L.C., P.O. BOX 828, BLOOMFIELD HILLS, MI, 48303, US

(21) Appl. No.: 10/369,423

(22) Filed: Feb. 18, 2003

(51) Int. Cl. H01M 8/04

(52) U.S. Cl. 429/25; 429/17

(57) ABSTRACT

A fuel cell system is provided with an oxidant supply that utilizes a centrifugal compressor that has a surge control system. The surge control system provides a recirculation port from the outlet compressor back to the compressor inlet. A valve is provided in the recirculation passage that allows the system to maintain its requested pressure and flow by selective reintroduction of compressed air to the inlet of the compressor. The recirculation subjects the compressor to a higher mass flow rate where it can make more pressure without surging, and thereby returns the compressor to an “on map” situation.

### FIELD OF THE INVENTION

The present invention relates to a fuel cell system, and more particularly, to surge avoidance and control of a centrifugal compressor in a fuel cell system.

### BACKGROUND OF THE INVENTION

Fuel cell systems typically require an air compressor to supply oxidant to the fuel cell stack. A centrifugal compressor has several advantages over other types of compressors in the area of size, mass, efficiency, air stream contamination, and sound attenuation. However, all centrifugal compressors have an operation map of pressure ratio (outlet pressure/inlet pressure) versus flow, such as illustrated in FIG. 2. As illustrated in FIG. 2, the pressure ratio versus flow map for a centrifugal compressor is bound by the surge line on the left, where the compressor suffers from a flow reversion caused by excessive back pressure, and the choke line on the right where maximum flow is reached with minimal pressure for a given compressor speed. A centrifugal compressor cannot be operated at pressures that put the machine into surge due to severe oscillation of the airflow through the compressor. Accordingly, it is desirable to provide a system that is capable of surge avoidance and control of a centrifugal compressor in a fuel cell system.

### SUMMARY OF THE INVENTION

The system of the present invention provides a system and method to detect and control the surging of a compressor. The system detects pre-surge pressure fluctuations, called incipient surge, which is used as an indicator of imminent surge. The fuel cell system includes a fuel cell stack having an anode flow passage and a cathode flow passage. A fuel source is connected to the anode flow passage, and an oxidant source is connected to the cathode flow passage. The oxidant source includes a passage including a compressor disposed therein and a recirculation passage connecting an outlet of a compressor with an inlet of a compressor. The recirculation passage includes a control valve for opening and closing the recirculation passage in response to detection of an incipient surge condition. In one aspect, the fuel source is a hydrogen-containing gas stream; preferably substantially hydrogen or a reformate. Other fuel sources include hydrocarbon, such as methane or methanol.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram of a fuel cell system having a centrifugal compressor and a surge avoidance system according to the principles of the present invention;

FIG. 2 is a graphical illustration of an operation map of pressure ratio (outlet pressure/inlet pressure) versus flow for a centrifugal compressor; and

FIG. 3 is a graphical illustration of pressure change and flow change over time during an incipient surge condition and a surge condition.

### DETAILED DESCRIPTION OF THE PREFERRED EMBODIMENTS

The following description of the preferred embodiment(s) is merely exemplary in nature and is in no way intended to limit the invention, its application, or uses.

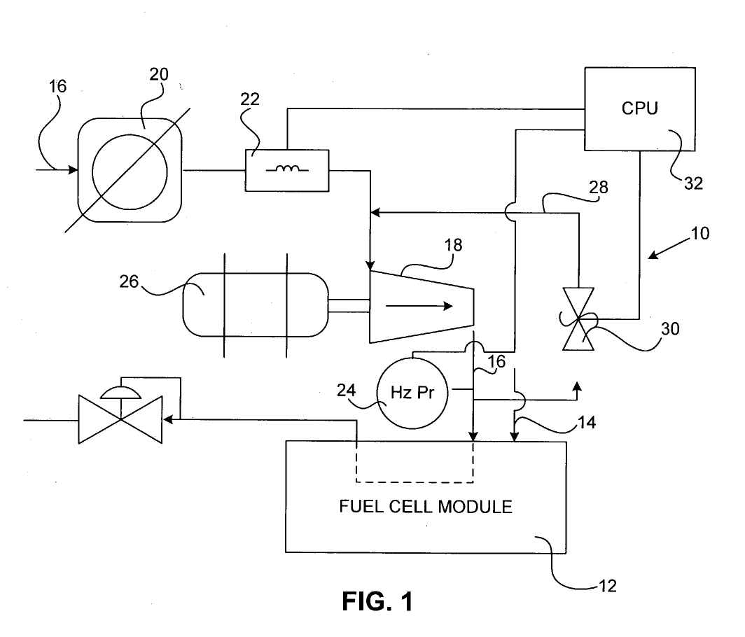

With reference to FIG. 1, a fuel cell system 10 is provided including a fuel cell stack 12 including an anode passage 14 providing fuel such as hydrogen, direct methanol, or hydrocarbon reformate, etc. to the fuel cell stack 12. A cathode passage 16 is provided for supplying oxidant to the fuel cell stack 12. The cathode passage 16 includes a compressor 18 which is preferably a centrifugal compressor. The cathode passage 16 is also provided with an inlet filter 20, mass flow meter 22, and pressure transducer 24. A motor 26 is provided for driving the compressor 18.

A recirculation passage 28 is connected to an outlet end of compressor 18 and an inlet end of compressor 18. A recirculation valve 30 is provided in a recirculation passage 28. The recirculation valve 30 is in a normally closed state, and is controlled by a controller 32 which receives signals from the pressure transducer 24 or a mass flow meter 22.

An incipient surge condition is detected by the controller 32 by monitoring either the pressure changes for oscillations using the pressure transducer 24 or oscillations in the airflow via the mass flow meter 22. When an incipient surge condition is detected, the controller 32 opens the recirculation valve 30 in response thereto. The recirculation valve 30 can be maintained in an open position for a predetermined period of time; until a load variance is experienced that would change the operating parameters of the fuel cell system; or by use of a closed loop control system wherein continual monitoring of either the pressure or airflow can be carried out and opening and closing of the recirculation valve 30 is controlled in order to avoid a surge condition. Opening of the recirculation valve 30 allows the system to maintain its requested pressure and flow by recirculation of compressed air from the outlet of the compressor back to its inlet. The result is that the compressor is subject to a higher mass flow rate where it can make more pressure without surging so that the compressor is returned to an “on map” situation.

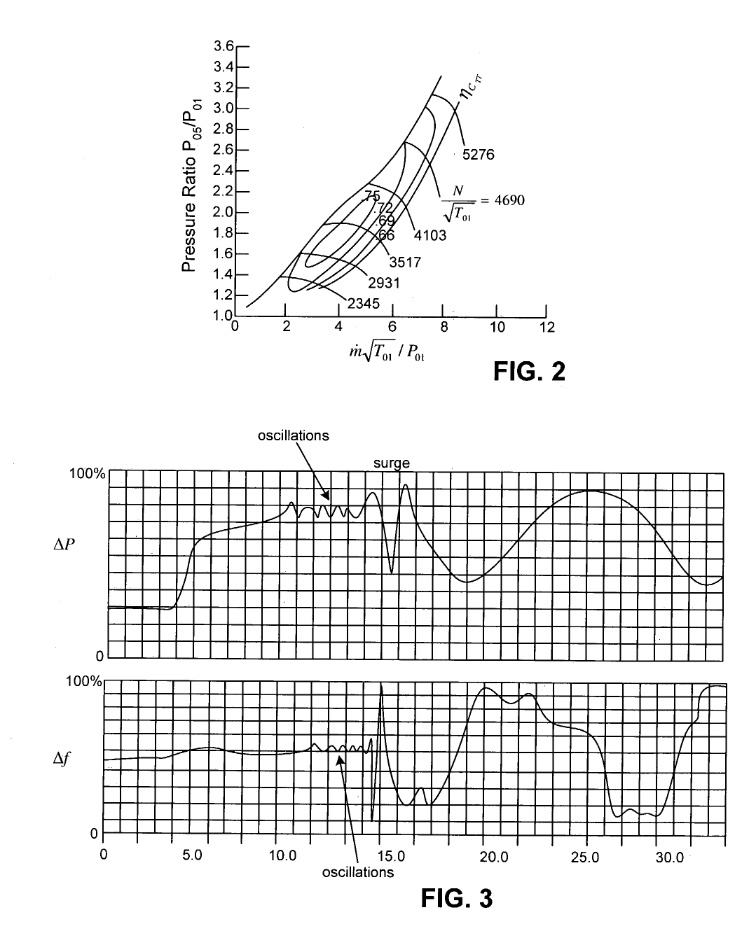

With reference to FIG. 2, for a specific pressure ratio, it can be seen that by increasing the mass flow rate on the bottom axis, as shown in FIG. 2, the pressure ratio versus flow position moves in a rightward direction away from the surge line. This recirculation of compressed air also presents acoustic advantages as compared to just “blowing off” the excess flow. By re-introducing the high pressure excess air to the compressor inlet, the audible whistle effect is minimized. Operation with a recirculation system can be beneficial to a fuel cell system during system transients and certain depressed inlet conditions, such as high temperature and altitude compensation.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel cell system, comprising:
a fuel cell stack including an anode flow passage and a cathode flow passage;
a fuel source connected to said anode flow passage; and
an oxidant source connected to said cathode flow passage, said oxidant source including a passage including a compressor disposed therein and a recirculation passage connecting an outlet of said compressor with an inlet of said compressor, said recirculation passage including a control valve for opening and closing said recirculation passage.

2. The fuel cell system according to claim 1, further comprising a pressure transducer for sensing a pressure in the cathode flow passage, said pressure transducer providing pressure signals to a control unit, said control unit monitoring said pressure signals and in response to detection of an incipient surge condition, said control unit opens said control valve in said recirculation passage.

3. The fuel cell system according to claim 1, further comprising an air flow sensor for sensing air flow through the cathode flow passage, said air flow sensor providing air flow signals to a control unit, said control unit monitoring said air flow signals and in response to detection of an incipient surge condition, said control unit opens said control valve in said recirculation passage.

4. A method of avoiding surge in a centrifugal compressor of a fuel cell system including a cathode passage connected to a fuel cell stack with the centrifugal compressor being disposed in the cathode passage, comprising:
detecting a pressure in a down stream outlet passage of said compressor; and
recirculating compressed gases from said outlet passage of said compressor to an inlet passage of said compressor in response to a detected incipient surge condition.

5. A method of avoiding surge in a centrifugal compressor of a fuel cell system including a cathode passage connected to a fuel cell stack with the centrifugal compressor being disposed in cathode passage, comprising:
detecting air flow through the cathode passage; and
recirculating compressed gasses from said outlet passage of said compressor to an inlet passage of said compressor in response to a detected incipient surge condition.
